(19) United States
(12) Patent Application Publication
(10) Pub. No.: US 2005/0201608 A1
(43) Pub. Date: Sep. 15, 2005

(54) Medical image reproducing system and medical image reproducing method

(75) Inventors: Mamoru Umeki, Tokyo (JP); Eiichi Akagi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/073,759

(22) Filed: Mar. 8, 2005

(30) Foreign Application Priority Data
Mar. 11, 2004 (JP) JP2004-069404

(51) Int. Cl. G06K 9/00

(52) U.S. Cl. 382/132

(57) ABSTRACT

In medical image processing system 100 related to this invention, when image data L and R which are created in image creating apparatus 1 are inputted into image processing apparatus 2, a position confirmation screen is displayed in which the chest wall side of image data L and the chest wall side of image data R adjoin one another. In this position confirmation screen, image data L and R are positioned in order to substantially match the position of both breasts to one another in the extensional direction of the common line between chest wall portions, and after the positions are determined, image data L and image data R are placed in an output image frame individually based on the positioning results and image data L and R for output are created to be outputted from image recording apparatus 3.

### BACKGROUND OF THE INVENTION

The present invention relates to a medical image reproducing system and a medical image reproducing method, in which left and right breast images are recorded and individually outputted on recording media.

Conventionally, a medical image which is converted into a digital image by various kinds of modalities such as CT (Computed Tomography), MRI (Magnetic Resonance Imaging), CR (Computed Radiography), FPD (Flat Panel Detector), which employ radiation, and ultrasonic diagnostic apparatus is displayed on a monitor such as a CRT (Cathode Ray Tube), and diagnostic observation is performed by a doctor, after various image processing, including a tone adjustment process. In another case, after various kinds of imaging processes, a medical image is recorded on a recording medium such as a film by an image recording apparatus for hard copy output and is diagnosed by a doctor on a light box or an illuminated viewing panel.

When a doctor diagnoses medical images of breasts (mammography), they are often diagnosed by means of comparative diagnosis while comparing images of each breast placed side by side, and when two hard-copied images of each breast are diagnosed by comparative diagnosis, a doctor diagnoses the images placed on an illuminated viewing panel with chest wall side of each image adjoining the other. To facilitate the comparative diagnosis on a illuminated viewing panel, for example, a positioning technique to output images so that the chest wall portions of each breast is outputted on the side edges of each film is disclosed in Patent Document 1.

[Patent Document 1] TOKKAI No. 2002-158853

When images of each breast are placed on an illuminated viewing panel, the possibility exists in which the position of the separate images of each breast does not match one another. In this case, a doctor typically removes one of the images from the illuminated viewing panel and diagnoses that image. while holding the film by hand to vertically adjust the position of the image against gravity to match the position of the image to the position of the breast in the other image, and therefore, the comparative diagnosis is rather difficult, and in such cases, doctors can not perform the comparative diagnosis efficiently.

### SUMMARY OF THE INVENTION

An objective of this invention is to make it possible that efficient comparative diagnosis of images of both breasts is carried out on an illuminated viewing panel.

The above objective can be achieved by the following system and method.

(A) A medical image reproducing system, including an image generating section to radiograph left and right breasts individually and to generate an image of the left breast and an image of the right breast, an allocating section to automatically allocate the generated images of the left and right breasts individually in respective image frames corresponding to a recording media for output, a positioning section to adjust the position of at least one of the image of the left breast and the image of the right breast in the respective image frames in such a way that when one of an upper end and a lower end of each of the image frame for the left breast and the image frame for the right breast is set as a reference end and the image frame for the left breast and the image frame for the right breast are placed side by side so as to make the reference end of the image frame for the left breast and the reference end of the image frame for the right breast to coincide to each other, the image of the left breast and the image of the right breast are located at substantially the same position from the reference end of each of the respective image frames, an image formatting section to produce image data for outputting the images of the left and right breasts at the adjusted position in the respective image frames, and an image recording section to record images of the left and right breasts on respective recording media based on the image data corresponding to the images of the left and right breasts produced by the image formatting section.

(B) A medical image reproducing method, including steps of radiographing left and right breasts individually to generate an image of the left breast and an image of the right breast, allocating automatically the generated images of the left and right breasts individually in respective image frames corresponding to a recording media for output, adjusting the position of at least one of the image of the left breast and the image of the right breast in the respective image frames in such a way that when one of an upper end and a lower end of each of the image frame for the left breast and the image frame for the right breast is set as a reference end and the image frame for the left breast and the image frame for the right breast are placed side by side so as to make the reference end of the image frame for the left breast and the reference end of the image frame. for the right breast to coincide to each other, the image of the left breast and the image of the right breast are located at substantially the same position from the reference end of each of the respective image frames,. producing image data for outputting the images of the left and right breasts at the adjusted position in the respective image frames, and recording images of the left and. right breasts on respective recording media based on the image data corresponding to the images of the left and right breasts produced by the image formatting section.

### BRIEF DESCRIPTION OF THE DRAWINGS

FIG. 1 is a diagram showing an overall composition of medical image processing system 100 related to this invention.

FIG. 2 is a block diagram showing the functional composition of image processing apparatus 2 in FIG. 1.

FIG. 3 is a flowchart showing the output. image creating process executed by CPU 21 in FIG. 2.

FIG. 4 is a view showing an example of position confirmation screen 231 displayed on display section 23 in FIG. 2.

### DETAILED DESCRIPTION OF THE PREFERRED EMBODIMENT

Preferred embodiments to achieve the aforementioned objective of this invention will be explained.

(1) In the medical image reproducing system (A) described above, when the image of the left breast and the image of the right breast are automatically allocated in the respective image frames, the image of the left breast and the image of the right breast are placed side by side in such a way that the chest wall side of the image of the left breast and the chest wall side of the image of the right breast adjoin one another.

(2) In the medical image reproducing system (A), an image generating section generates image data of the left breast corresponding to the image frame for the left breast and image data of the right breast corresponding to the image frame for the right breast respectively.

(3) In the medical image reproducing system (A), the positioning section has a display section to display the image frame for the left breast and the image of the left breast and the image frame for the right breast and the image of the right breast on the same screen, and a data processing section to adjust the position of the images of the breasts displayed in the image frames.

(4) In the medical image reproducing method (B) described above, the image of the left breast and the image of the right breast are placed side by side in such a way that the chest wall side of the image of the left breast and the chest wall side of the image of the right breast adjoin one another in the allocating step.

(5) In the medical image reproducing method (B), the image data of the left breast corresponding to the image frame for the left breast and image data of the right breast corresponding to the image frame for the right breast are generated respectively in the radiographing step.

(6) In the medical image reproducing method (B), the positioning step has steps of displaying the image frame for the left breast and the image of the left breast and the image frame for the right breast and the image of the right breast on the same screen and adjusting the position of the images of the breasts displayed in the image frames.

In order to achieve the aforementioned objective., another preferred embodiment will be explained.

The medical image reproducing system (A) is composed of an image creating section to create an image of the left breast and an image of the right breast after radiographing both breasts individually, a positioning section to position the created image of the left breast and the created image of the right breast such that the position of the left breast and the position of the right breast are substantially aligned with one another in the extended-direction of a common line between both chest wall portions when the created image of the left breast and the created image of the right breast are placed side by side with the chest wall side of the image of the left breast and the chest wall side of the image of the right breast adjoining one another, a formatting section which individually places the image of the left breast and also the image of the right breast in an output image frame, based on the result of the positioning and creates a left breast image for output and a right breast image for output and an image recording section which records each of the images for output of both breasts on a recording medium individually and outputs the images.

The medical image reproducing method (B) is composed of steps for creating an image of the left breast and an image of the right breast after radiographing both breasts individually, positioning the created image of the left breast and the created image of the right breast such that the position of the left breast and the position of the right breast are substantially aligned with one another in the extended direction of a common line between both chest wall portions when the created image of the left breast and the created image of the right breast are placed side by side with the chest wall side of the images of the left breast and the chest wall side of the image of the right breast adjoining one another, formatting the images by placing. the image of the left breast and the image of the right breast individually in an output image frame, based on the result of the positioning and by creating a left breast image for output and also a right breast image for output, and recording each of the images for output of both breasts on a recording medium individually to output the images.

According to the invention of (A) and (B), an image of the left breast and an image of the right breast are created after radiographing both breasts individually, and the created image of the left breast and the created image of the right breast are positioned such that the position of the left breast image and the position of the right breast image are substantially aligned with one another in the extended direction of a common line between both chest wall portions when the image of the left breast and the image of the right breast are placed side by side with the chest wall side of the image of the left breast and the chest wall side of the image of the right breast adjoining one another, and the image of the left breast and the image of the right breast are placed individually in an output image frame based on the positioning result so that a left breast image for output and a right breast image for output are created, and both of the images for output of both breasts are recorded individually on a recording medium and outputted. Accordingly, when a doctor places the images of both breasts side by side on an illuminated viewing panel with the chest wall side of the image of left breast and the chest wall side of the image of right breast adjoining one another and conducts comparative diagnosis of the images of both breasts, there is no possibility that the position of both breasts are located uneven, making comparative diagnosis easier and it is possible to perform a comparative diagnosis effectively.

Next, a structure of the embodiment will now be explained.

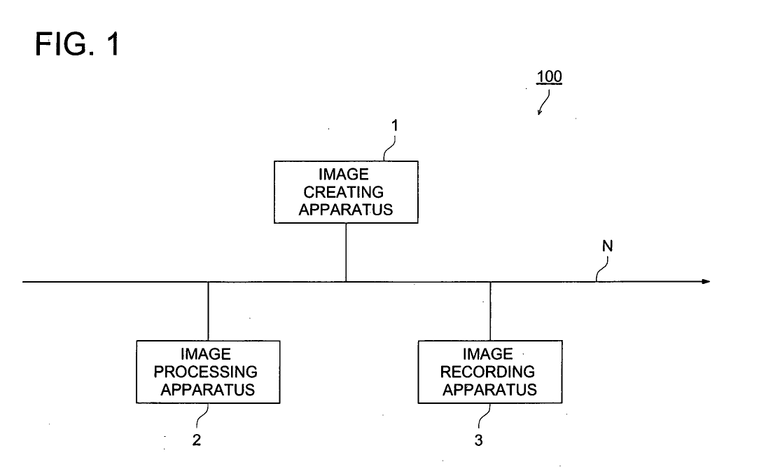

FIG. 1 is a schematic view showing the overall structure of medical image processing system 100 of this embodiment. As shown in FIG. 1, medical image processing system 100 is composed of image creating apparatus 1, image processing apparatus 2 and image recording apparatus 3 via network N, enabling interchange of data.

In this embodiment, an example in which image creating apparatus 1, image processing apparatus 2 and image recording apparatus 3 are connected through a network is explained, however the embodiment is not limited to this and it can be a system structured so that each apparatus is connected directly with lines to one another. The number of apparatuses of each kind and the place where each apparatus is installed are not restricted.

Various kinds of network N such as LAN (Local Area Network), WAN (Wide Area Network) and the Internet are applicable. If it is allowed in medical facilities such as a hospital, wireless communication and infrared communication are also possible, however it is preferable that the information of patient transmitted and received is coded, because it includes important information of patients. Generally, as a communication system in a hospital, DICOM. (Digital Image and Communications in Medicine) standard is used and DICOM MWM (Modality Worklist Management) and DICOM MPPS (Modality Performed Procedure Step) are used for communication between apparatuses of aforementioned network N.

Image creating apparatus 1 is an image creating means and is composed of modalities such as CR (Computed Radiography), FPD (Flat Panel Detector), CT (Computed Tomography), MRI (Magnetic Resonance Imaging) and ultrasonic diagnostic apparatuses, and is a apparatus which photographs portions of a patient and converts. the image into digital data and creates a medical image. In this embodiment, image creating apparatus 1 applies radiography to both breasts and creates corresponding image data for left breast and image data for right breast.

Regarding image data which are created in image creating apparatus 1 and outputted to image processing apparatus 2, it is, for example, preferable for mammography (radiographic image of the breast) that effective pixel size is smaller than 200 μm, and being smaller than 100 μm is further preferable, though it depends on the radiographed body part or the purpose of diagnosis. The structure in which image data are created of an effective pixel size of, for example, approximately 50 μm is preferably used to exemplify the maximum performance of image processing apparatus 2 of this invention.

Image creating apparatus 1 is an apparatus based on afore-stated DICOM standard, and can input supplementary image information of DICOM (hereinafter refer to as supplementary information) to a medical image and can also automatically create information to the image. Image creating apparatus 1 outputs the supplementary data into image processing apparatus 2 via network. N as header information of image data as well as created image data of medical image, however if it is not based on DICOM standard, it can input supplementary information by means of an unillustrated DICOM converter.

As supplementary information for medical images, included is patient information related to radiographed patients such as patient name, patient ID, age, sex, and the radiography information such as date of the radiography, examination ID, body part, radiographing condition (for example posture and shooting direction), information of the image creating apparatus (the kind of modality).

Image processing apparatus 2 is an apparatus which creates image data for output, by conducting various kinds of processes to a medical image supplied from image creating apparatus 1, to improve the efficiency of a doctor's diagnosis of the image, and sends the image data to image recording apparatus 3.

Image recording apparatus 3 is an image recording means which outputs a hard copy of recording media (here, it is a film) on which a medical image is reproduced as a visualized image, based on image data for output received from image processing apparatus 2.

The internal structure of image processing apparatus 2 will now be explained hereinafter.

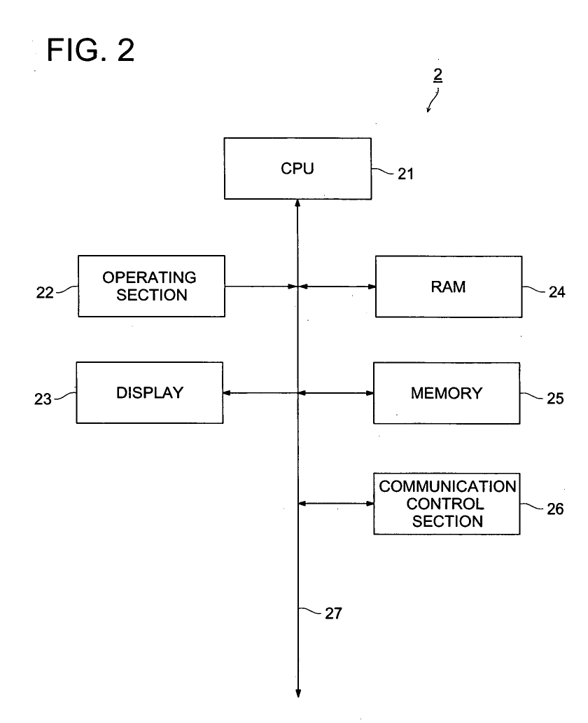

FIG. 2 is a block diagram showing the functional structure of image processing apparatus 2. As shown in FIG. 2, image processing apparatus 2 is composed of CPU 21, operating section 22, display section 23, RAM 24, memory 25, communication control section 26 each of which is connected to bus 27.

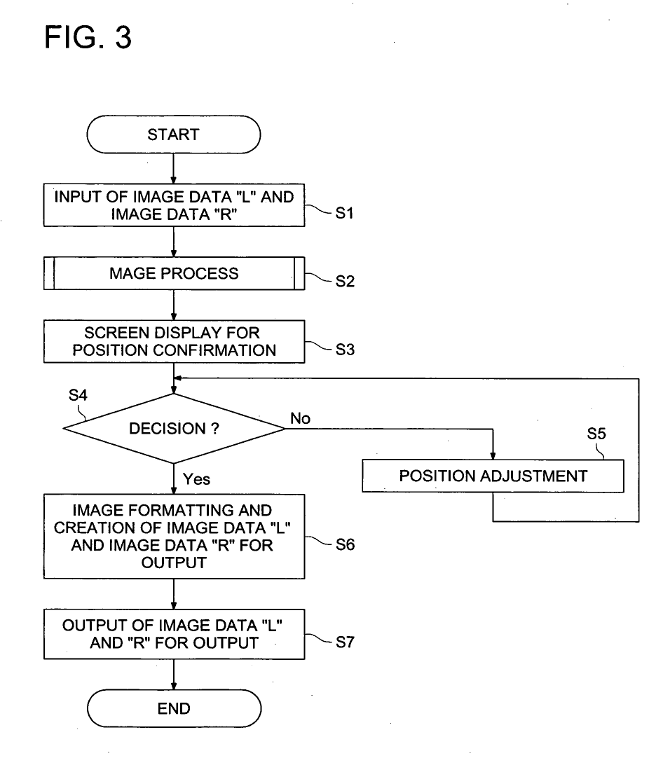

CPU 21 reads out a system program stored in memory 25 and develops it in a work area formed in RAM 24 and controls each section according to the system program. CPU 21 reads out various process programs and various application programs stored in memory 25, including an output image creating process program and an image processing program, to develop them in work area and performs various kind of processes including an output image creating process (refer to FIG. 3) to be explained later.

Operating section 22 is composed of a keyboard equipped with cursor keys, number input keys, various kinds of function keys and pointing sections such as a mouse, and outputs instruction signals inputted by keying operations on the keyboard or by mouse operation, to CPU 21. Operating section 22 may also be equipped with a touch panel on a display screen of display section 23. In such case, an instruction signal which was inputted with the touch panel is outputted to CPU 21.

Display section 23 is composed of LCD (Liquid Crystal Display) or CRT monitors, and displays input instruction and data sent from operating section 22 according to instruction of display signals inputted from CPU 21.

RAM 24 forms a work area which temporarily stores various kinds of programs executable in CPU 21, input or output data and parameters which are read out from memory 25 for various kinds of processes performed and controlled in CPU 21.

Memory 25 is composed of an HDD (Hard Disc Drive) and an involatile semiconductor memory, and stores system programs to be executed by CPU 21, various process programs corresponding to the system programs, including an output image creating process program, an image process program, as well as various application programs and various data. These programs are stored as a readable form of program codes , and CPU 21 executes operations according to the program codes, in sequence.

Communication control section 26 is equipped with a LAN adaptor, a router, a TA (Terminal Adapter), and controls communication among apparatuses within network N.

Next, operations of the embodiment will be explained. FIG. 3 is a flowchart showing an output image creating process executed by CPU 21 in image processing apparatus 2. CPU 21 executes the output image creating process, to realize a positioning means, an image formatting means by a soft wear process in cooperation with an output image creating program incorporated in memory 25.

First, image data of the left breast (hereinafter, called image data L) obtained by radiographing the left breast and image data of right breast (hereinafter, called image data R) obtained by radiographing the right breast are inputted from image creating apparatus 1 via communication control section 26 and stored in the work. area in RAM 24 (Step S1). Next, an image processing program is read out and an image process is applied to both image data L and image data R (Step S2).

The image process includes a tone adjusting process to adjust image contrast, a frequency process to adjust the sharpness and a dynamic range compression process which maintains the image of broad dynamic range to be within a preferable density range for comfortable viewing, without reduction of contrast in details of the radiographed object. Each of image data L and R is analyzed to recognize the area of the object and density correction is carried out to achieve a density at least as high as the predetermined value, for example a density value higher than the minimum density value in the area of an object, to areas other than the area of an object. The density correction serves to prevent influence from the light of the illuminated viewing panel transmitting through the film when the film is viewed.

Regarding recognition of the area of the object, for example, image data L and image data R are analyzed respectively and sampling of profiles of the objects is conducted. For example, respective density data of image data L and image data R are binarized by using an appropriate distinguishing values and border line between “0” and “1” is traced to complete a profile and the area of the object is determined corresponding to the profile and radiographed parts/position and radiographing direction. The area of the object can also be determined by means of a “Profile sampling method of an area corresponding to a prescribed anatomical structure of the human body area or interior of the human body ” (magazine of Japan Association of Breast Cancer Screening Vol. 17, No. 1, pp 87-102, 1998, TOKKAI No. SYOU63-240832).

Next, image data L and R which has been image-processed are arranged to positions so that both chest walls adjoin each other, and displayed on position confirmation screen 231. of display section 23 (Step S3). When a determination of the position is instructed from position confirmation screen 231 (Step S4; YES), the process moves to Step S6. When a determination of the position is not instructed (Step S4; NO) and the position of image data L and image data R are adjusted on position confirmation screen 231 (Step S5), the process returns to Step 4. After adjusting the positions, the process advances to Step S6 when the position determination is instructed (Step S4; YES). At this time, the result of positioning, that is, the adjusting amount is stored in RAM 24 as positioning information.

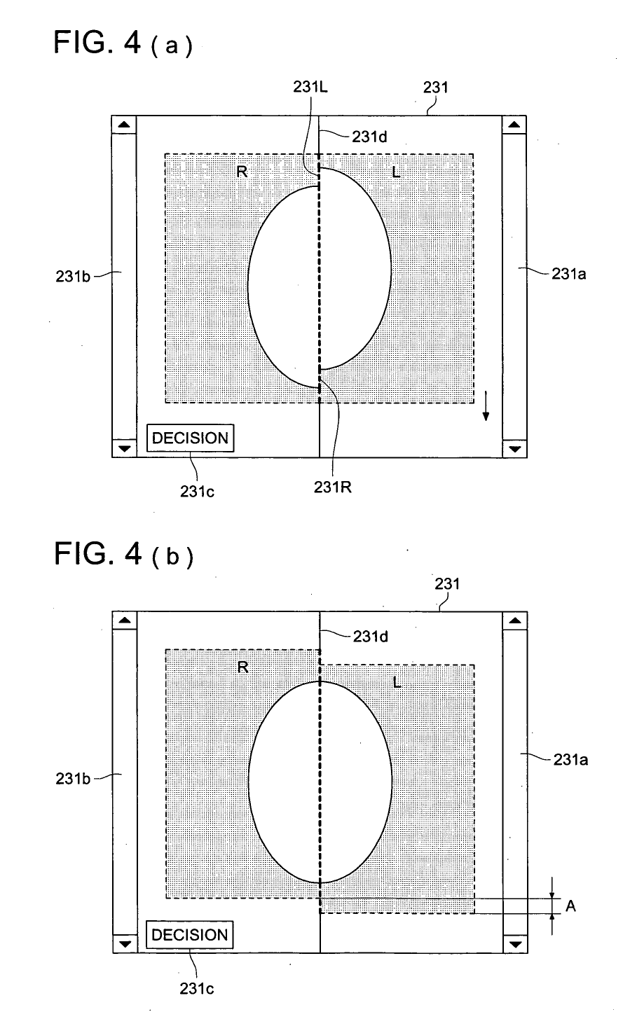

An example of position confirmation screen 231 is shown in FIGS. 4(a) and 4(b). As shown in FIG. 4, image data L and R are positioned so that the chest wall sides of the images adjoin each other in position confirmation screen 231, and therefore, the positioning relationship at the stage when image data L and R are hard-copied and arranged on an illuminated viewing panel can be confirmed. Here, line 231L shown in FIG. 4(a) indicates the border line of the left chest wall portion in image data L, and line 231R indicates the border line of the right chest wall portion in image data R. Line 231d indicates the extended common line between both chest walls. Scroll bars 231a and 231b are displayed on the right side and the left side of position confirmation screen 231 respectively. When scroll bar 231a is operated by operating section 22, such as a mouse, the position of image data L is adjusted in the vertical direction, that is, along the extended common line between both chest wall portions on the screen. When scroll bar 231b is activated by operating section 22 such as a mouse, the position of image data R is adjusted in the vertical direction, that is, the extensional direction of the common line of both chest wall portions in the screen. Decision button 231c is displayed at the lower left side of position confirmation screen 231, and the position of each image can be fixed when decision button 231c is activated by operating section 22 such as a mouse.

For example, when position confirmation screen 231, of Step S3, is as in FIG. 4(a ), and if the data are outputted as hard copies and these hard copies are placed on an illuminated viewing panel without any processing, the position of the left breast image is located above that of the right breast image. Therefore, the downward arrow of scroll bar 231a is applied to shift image data L of left breast downward by distance “A” relative to image data R of the right breast, and then, the position of both breasts can be aligned to one another as shown in FIG. 4 (b ). The positions of both breasts are substantially aligned to one another along the extended common line between both chest walls.

Here, image data L and image data R are illustrated as CC(Cranial Caudal) images which are created by radiographing of breasts in the vertical direction, however MLO (Medio Lateral Oblique) images which are created by radiographing of breasts in an oblique direction can be adjusted in the same manner. Although the example was given above in which the position of image data L is shifted for adjustment relative to the position of image data R, the position of image data R can be shifted relative to the position of image data L.

After the position of image data is determined, formatting of image is carried out to each of image data L and R and left breast image data for output (hereinafter, refer to as image data L for output) and right breast image data for output (hereinafter, image data R for output) are created respectively (Step S6). The formatting of an image includes processes such as rotation, reversal, enlargement/reduction, positioning in the output image frame, darkening in vacant areas which have no image in the output image frame (a process to raise the density value higher than the prescribed density value, for example, higher than the minimum density value of the area of an object). When the positioning is carried out in Step S5, the image is located in the output image frame based on positioning information as a result of positioning (information indicating the adjusting direction and the adjusting amount, for example, in case of FIG. 4(b ), information indicating that image data L were shifted downward by distance “A” to adjust the position relative to image data R). For example, when positioning is carried out as shown in FIG. 4(b) in Step 5, image data L are located so that the position of them are shifted downward by distance “A”, relative to the position of image data R. Image data which are not included in output image frame are deleted. When there is an area without any data in the output image frame, that vacant area is subjected to the darkening process.

The output image frame is made to correspond to the film size when it is outputted by image recording apparatus 3, and further, film of the same size is used for both left and right sides. In this embodiment, image recording apparatus 3 records an image on eight-by-ten inch film, however when image recording apparatus 3 has plural film supply trays and when it is feasible to record images onto film of plural sizes, the film size may be set by an instruction of a user from operating section 22 and it may also be arranged that the film size is set automatically based on the information of the size of film which is recordable in image recording apparatus 3, as well as based on image data size.

When the formatting of image is finished and image data L and R for output are created, the created image data L and R for output are sent to image recording apparatus 3 via communication control section 26 to finish the process (Step S7).

In image recording apparatus 3, when image data L and R for output are received, images are recorded on the sheets of film and outputted one after another.

As explained above, in medical image processing system 100, when image data L and R of both breasts which are created in image creating apparatus 1 are inputted into image process apparatus 2, image processing is applied to image data L and R, and position confirmation screen 231 is displayed with image data L and R positioned so that the chest wall sides of image data L and R adjoin each other. In position confirmation screen 231, the left image data L and the right image data R are positioned in order to substantially align the position of both breast images to one another along the extended common line between chest wall portions, and after the positions are determined, image data L and R are individually placed in an output image frame based on the positioning result and a image formatting process is applied to create image data L and R for output, and they are sent to image recording apparatus 3. In image recording apparatus 3, each image of both breasts is recorded individually, based on the image data for output, on a recording medium to be outputted.

Accordingly, when hard copies of images of each breast are placed on an illuminated viewing panel, the position of both breast images match one another, so that it is not necessary for doctors to remove one of the images from the illuminated viewing panel, and to diagnose the image while holding the image by hand to maintain the adjusted position, after the position of the image is adjusted vertically by hand to align the position of the image to that of the other image, and therefore, comparative diagnosis becomes easier. As a result, doctors can perform the comparative diagnosis more efficiently.

The above-mentioned embodiment is a preferable example of medical processing system 100 related to this invention, but is not limited to this embodiment.

For example, in the above-mentioned embodiment, it was explained that image formatting is carried out in image processing apparatus 2, however formatting information such as positioning, image layout, enlargement/reduction, reversal/rotation and darkening can be sent to image recording apparatus 3 as supplementary information, with image-processed image data L and R, and image formatting can be carried out in image recording apparatus 3.

Once image data L and R, and positioning information are stored in memory 25 for correlation to each other, printing can be conducted for a short time preferably when a recall and a reprint of an image are done, because of elimination of the repositioning process.

Detailed structure and detailed operation of each device composing medical image processing system 100 can be changed appropriately without departing from the spirit of this invention.

1. A medical image reproducing system, comprising:
an image generating section to radiograph left and right breasts individually and to generate an image of the left breast and an image of the right breast;
an allocating section to automatically allocate the generated images of the left and right breasts individually in respective image frames corresponding to a recording media for output;
a positioning section to adjust the position of at least one of the image of the left breast and the image of the right breast in the respective image frames in such a way that when one of an upper end and a lower end of each of the image frame for the left breast and the image frame for the right breast is set as a reference end and the image frame for the left breast and the image frame for the right breast are placed side by side so as to make the reference end of the image frame for the left breast and the reference end of the image frame for the right breast to coincide to each other, the image of the left breast and the image of the right breast are located at substantially the same position from the reference end of each of the respective image frames;
an image formatting section to produce image data for outputting the images of the left and right breasts at the adjusted position in the respective image frames; and
an image recording section to record. images of the left and right breasts on respective recording media based on the image data corresponding to the images of the left and right breasts produced by the image formatting section.

2. The medical image reproducing system of claim 1, wherein when the image of the left breast and the image of the right breast are automatically allocated in the respective image frames, the image of the left breast and the image of the right breast are placed side by side in such a way that the chest wall side of the image of the left breast and the chest wall side of the image of the right breast adjoin one another.

3. The medical image reproducing system of claim 1, wherein an image generating section generates image data of the left breast corresponding to the image frame for the left breast and image data of the right breast corresponding to the image frame for the right breast respectively.

4. The medical image reproducing system of claim 3, wherein the positioning section comprises:
a display section to display the image frame for the left breast and the image of the left breast and the image frame for the right breast and the image of the right breast on the same screen, and
a data processing section to adjust the position of the images of the breasts displayed in the image frames.

5. A medical image reproducing method, comprising steps of:
radiographing left and right breasts individually to generate an image of the left breast and an image of the right breast;
allocating automatically the generated images of the left and right breasts individually in respective image frames corresponding to a recording media for output;
adjusting the position of at least one of the image of the left breast and the image of the right breast in the respective image frames in such a way that when one of an upper end and a lower end of each of the image frame for the left breast and the image frame for the right breast is set as a reference end and the image frame for the left breast and the image frame for the right breast are placed side by side so as to make the reference end of the image frame for the left breast and the reference end of the image frame for the right breast to coincide to each other, the image of the left breast and the image of the right breast are located at substantially the same position from the reference end of each of the respective image frames;
producing image data for outputting the images of the left and right breasts at the adjusted position in the respective image frames; and
recording images of the left and right breasts on respective recording media based on the image data corresponding to the images of the left and right breasts produced by the image formatting section.

6. The medical image reproducing method of in claim 5, wherein in the allocating step, the image of the left breast and the image of the right breast are placed side by side in such a way that the chest wall side of the image of the left breast and the chest wall side of the image of the right breast adjoin one another.

7. The medical image reproducing method of claim 5, wherein in the radiographing step, the image data of the left breast corresponding to the image frame for the left breast and image date of the right breast corresponding to the image frame for the right breast are generated respectively.

8. The medical image reproducing method of claim 7, wherein the positioning step comprises steps of:
displaying the image frame for the left breast and the image of the left breast and the image frame for the right breast and the image of the right breast on the same screen and
adjusting the position of the images of the breasts displayed in the image frames.
